(19) United States
(12) Patent Application Publication
(10) Pub. No.: US 2008/0182128 A1
(43) Pub. Date: Jul. 31, 2008

(54) Process For Preparing Piezoelectric Materials

(75) Inventors: Philippe Boy, Joue Les Tours (FR); Gilles Ehrhart, Lille (FR); Phillippe Belleville, Tours (FR)

Correspondence Address: HUTCHISON LAW GROUP PLLC, PO BOX 31686, RALEIGH, NC, 27612, US

(73) Assignee: COMMESSARIAT A L'ENERGIE ATOMIQUE, Paris (FR)

(21) Appl. No.: 11/629,589

(22) PCT Filed: Jun. 16, 2005
(86) PCT No.: PCT/FR05/50453

§ 371 Date: Dec. 14, 2006

(30) Foreign Application Priority Data
Jun. 17, 2004 (FR) 04 51289

(51) Int. Cl. B05D 5/12; B32B 9/00

(52) U.S. Cl. 428/697; 427/100

(57) ABSTRACT

The invention concerns a method for preparing a material based on piezoelectric ceramic oxide(s) comprising the following steps: a) wet deposition on at least one surface of a substrate of a layer of a dispersion comprising a piezoelectric ceramic oxide powder and a piezoelectric ceramic oxide precursor sol-gel solution identical to or different from the piezoelectric oxide constituting the powder; b) repeating a) once or several times, so as to obtain a stack of at least two layers; c) heat-treating said layers so as to transform them into corresponding ceramics; d) wet-shrink impregnation of the stack obtained at c) with a sol-gel solution identical to the one used in step a); e) optionally repeating step d) once or several times; f) heat-treating said stack, so as to transform the sol-gel impregnating the stack into the corresponding piezoelectric ceramics.

### TECHNICAL FIELD

The subject of the present invention is a process for preparing piezoelectric materials made of oxide ceramic by the sol-gel route.

The subject of the present invention is also piezoelectric materials that can be obtained by this process.

Piezoelectric materials are particular dielectric materials that allow the energy of an elastic deformation to be converted into electrical energy. More precisely, these materials have the capacity to be polarized when they are mechanically stressed, the charge that appears on their surface being proportional to the deformation induced. Such materials may be applicable in fields as varied as the design of piezoelectric lighters, transducers and actuators, ultrasonic generators or receivers, and tactile interfaces.

Among piezoelectric materials is a subclass formed by pyroelectric materials which have, in addition, a natural polarization along a preferential axis, called the spontaneous polarization axis. The magnitude of this polarization depends strongly on the temperature, hence their name. These pyroelectric materials are applicable in the detection field, more particularly the infrared detection field.

Finally, among piezoelectric materials there may also be mentioned ferroelectric materials, which have the particular feature of being able to be polarized in two or more directions, each direction being equally probable. By applying an electric field, it is possible to switch the polarization from one direction to the other. It is this phenomenon that is largely responsible for the piezoelectric properties of these materials, the switching locally modifying the crystal structure of these materials and making the effect much more pronounced than in other materials. Such materials are of course applicable in the field of actuators and transducers.

### PRIOR ART

The piezoelectric materials that have been the subject of numerous studies over the years are in the form of oxide ceramic materials. Samples of piezoelectric materials in oxide ceramic form that have been developed over the years include materials of a perovskite structure, such as lead zirconate titanate, (called PZT), barium strontium titanate (BST), lead niobium zinc titanate (PZNT), lead magnesium niobate (PMN), lead titanate (PT), potassium calcium niobate, bismuth potassium titanate (BKT) and strontium bismuth titanate (SBT).

These piezoelectric materials of oxide ceramic type may be obtained by processes in the vapour phase, plasma phase, solid phase or liquid phase.

For processes taking place in the vapour phase, the most commonly used process is evaporation, in which the ceramic to be deposited is placed in a crucible heated to a temperature such that vapours form and recondense in the form of a coating or film on a cooled substrate.

For processes involving a plasma phase, mention may be made of sputtering. In this technique, the ceramic material to be deposited is bombarded by ions generated by a plasma. The kinetic energy of the ions in the plasma is transferred to the atoms of the material to be deposited, which are projected at high velocity onto the substrate to be coated and are deposited thereon in the form of a coating or film.

For processes taking place in the solid phase, mention may be made of the decomposition of organometallic compounds, which consists in thermally decomposing these ceramic precursor compounds at a temperature high enough to cause, on the one hand, elimination of the organic substances formed during this decomposition and, on the other hand, ceramization.

Mention may also be made of a technique involving a solid/liquid dispersion consisting in mixing a ceramic powder with an organic solvent, in depositing this dispersion in the form of a film on a substrate and in heat treating this film. Another technique consists in sintering a ceramic powder on a substrate with addition of adhesive. In these two techniques, the thickness of the films cannot be precisely controlled.

However, these processes (in the vapour phase, plasma phase and solid phase) require the use of very high temperatures (generally above 1000° C.) and the installation of a refractory apparatus.

One way of circumventing these problems is to use a route taking place only in the liquid phase, which is none other than the sol-gel process.

The sol-gel process consists firstly in preparing a solution containing precursors of the oxide ceramics in the molecular state (organometallic compounds, metal salts), thus forming a sol (also called sol-gel solution). Secondly, this sol is deposited, in the form of a film, on a substrate. Upon contact with ambient moisture, the precursors hydrolyse and condense to form an oxide lattice trapping the solvent, resulting in a gel. The layer of gel forming a film is then heat treated so as to form a ceramic film.

The sol-gel process has many advantages over the abovementioned processes:
it allows coatings to be produced on complex surfaces;
it provides coatings that are homogeneous in terms of composition and thickness; and
owing to the fact that mixing of the species takes place on the molecular scale, it is possible by this process to produce complex oxides comprising, for example, three or more elements.

However, it is difficult to achieve thicknesses of greater than 1 μm by depositing films via the sol-gel route.

Now, the diversity of applications for piezoelectric materials means that these materials have a very wide range of thicknesses, which may go from around 100 nanometres to around 100 microns. To achieve thicknesses greater than 1 μm, some authors have proposed to use, as deposition solution, a dispersion comprising, as continuous dispersion medium, a sol-gel solution as precursor of the piezoelectric oxide ceramic and as dispersed phase a powder of said piezoelectric oxide ceramic.

Thus, D. A. Barrow et al. in Surface and Coatings Technology 76-77 (1995), pages 113-118 [1] describe a process for preparing a piezoelectric coating made of lead zirconate titanate (PZT) having a thickness of 10 μm or higher. This process comprises the deposition on a substrate of several films of a PZT ceramic precursor sol-gel solution comprising a dispersion of a powder of said ceramic, followed by an appropriate heat treatment. After this process, the coating obtained has, owing to the composite nature of the solution used, many surface irregularities and a very high level of porosity. This has the consequence of giving materials of low dielectric constant.

To remedy the abovementioned drawbacks, the authors Dorey et al. in Integrated Ferroelectrics, 2002, Vol. 50, pp 111-119 [2] have proposed to follow each step of depositing a film of the dispersion, as defined above, after heat treatment of said film, by a step of impregnating said film with a sol-gel solution containing no powder. Although these processes help to improve the relative permittivity of the materials obtained, they do not seem to have a pronounced influence on the value of the piezoelectric constant d₃₃, which does not exceed 70 pC/N.

The inventors have therefore set the objective of providing a process for obtaining piezoelectric materials of low roughness and having a higher piezoelectric constant than that of the materials of the prior art, while also being simpler to implement.

### SUMMARY OF THE INVENTION

The inventors achieved the objective that they were set by the present invention, the subject of which is a process for preparing a material based on one or more piezoelectric oxide ceramics, which comprises, in succession, the following steps:
a) deposition by a liquid route, on a substrate, of a layer of a dispersion comprising a powder of an oxide ceramic and a sol-gel solution as precursor of an oxide ceramic, the oxide ceramic powder being piezoelectric and/or the sol-gel solution being a precursor of a piezoelectric oxide ceramic;
b) repetition of step a), one or more times, so as to obtain a multilayer film consisting of at least two layers;
c) heat treatment of said layers for the purpose of converting them into the corresponding ceramic(s);
d) impregnation of the multilayer film obtained at step c) by dip coating it with a sol-gel solution identical to or different from that used in step a);
e) repetition of step d) one or more times; and
f) heat treatment of said multilayer film, for the purpose of converting the sol-gel solution impregnating the multilayer film into the corresponding ceramic.

The process of the invention makes it possible to overcome a number of drawbacks of the processes of the prior art and especially those stemming from the abovementioned document [2]. This is because the step of impregnating the entire multilayer film with a sol-gel solution, not impregnating it layer by layer, helps to considerably simplify the processes of the prior art. In addition, the authors have demonstrated that the piezoelectric properties of the materials obtained by the process of the invention are considerably improved.

According to the invention, the process comprises, firstly, a step of depositing, on a substrate, a layer of a dispersion comprising a powder of an oxide ceramic and a sol-gel solution as precursor of an oxide ceramic, the oxide ceramic powder being piezoelectric and/or the sol-gel solution being a precursor of a piezoelectric oxide ceramic, this deposition taking place in liquid processing.

It should be pointed out that as a first option, either the oxide ceramic powder is piezoelectric or the sol-gel solution is a precursor of a piezoelectric oxide ceramic, or vice versa. As a second option, the oxide ceramic powder is piezoelectric and also the sol-gel solution is a precursor of a piezoelectric oxide ceramic. In this case, the piezoelectric oxide ceramic powder may have a composition identical to the piezoelectric oxide ceramic that will result from the heat treatment of the precursor sol-gel solution.

Among the liquid processing deposition techniques, the following may be envisaged:
dip coating;
spin coating;
laminar-flow coating or meniscus coating;
spray coating; and
doctor-blade coating.

Among these techniques, the most advantageous one is the technique of dip coating, which makes it possible to achieve excellent results and especially allows deposition on substrates of complex shape.

The substrate on which the layer of dispersion is deposited may be of various types.

Advantageously, this substrate must not contaminate the deposited layer by, for example, the migration of ions, during heat treatments, and must ensure good adhesion of the layer. Advantageously, its softening temperature must be above the temperature of the heat treatments carried out on the deposited layers and its thermal expansion coefficient must be compatible with that of said layers in order to limit stress during annealing.

In particular, the substrate may be chosen from substrates made of the following materials: stainless steel; steel containing nickel; silicon, optionally metalized; aluminium; alumina; titanium; carbon; glass; or a polymer.

In particular, when the substrates are metal based, such as steel, aluminium or titanium substrates, it may be advantageous to deposit, on the surface of the substrate (which serves as support for the deposition of the dispersion layer), a dense layer of an oxide chosen for example from SiO₂, Ta₂O₅, ZrO₂, Al₂O₃, TiO₂, PZT, BST and combinations thereof.

This layer will act as a barrier layer and thus prevent the diffusion during the heat treatment of atoms belonging to the substrate into the multilayer film. This barrier layer may be obtained by depositing on the substrate a sol-gel solution as precursor of the constituent oxide ceramic(s) of this layer, it being possible for such a sol-gel solution to be deposited in one of the abovementioned liquid deposition techniques.

The dispersion that is deposited in the form of layers on the substrate is conventionally obtained by dispersing an oxide ceramic powder in a sol-gel solution as precursor of an oxide ceramic, the oxide ceramic powder being piezoelectric and/or the sol-gel solution being a precursor of a piezoelectric oxide ceramic, the powder thus constituting the dispersed phase while the sol-gel solution constitutes the continuous dispersion medium.

Advantageously, the oxide ceramic powder is piezoelectric and the sol-gel solution is also a precursor of a piezoelectric oxide ceramic.

When the oxide ceramic powder is a piezoelectric ceramic powder, it is advantageously chosen from lead zirconate titanate (PZT), barium strontium titanate (BST), lead niobium zinc titanate (PZNT), lead magnesium niobate (PMN), lead titanate (PT), potassium calcium niobate, bismuth potassium titanate (BKT) and strontium bismuth titanate (SBT).

As regards the sol-gel solution as precursor of a piezoelectric oxide ceramic, this is advantageously a precursor of ceramics chosen from lead zirconate titanate (PZT), barium strontium titanate (BST), lead niobium zinc titanate (PZNT), lead magnesium niobate(PMN), lead titanate (PT), potassium calcium niobate, bismuth potassium titanate (BKT) and strontium bismuth titanate (SBT).

When the oxide ceramic powder is piezoelectric and the sol-gel solution is a precursor of a piezoelectric oxide ceramic, the constituent oxide ceramic of the powder may have a composition identical to that of the oxide ceramic that will result from the heat treatment of the sol-gel solution in which the powder is dispersed.

The powder according to the invention is a powder that is commercially available or can be prepared beforehand.

Thus, the oxide ceramic powder may be prepared by conventional powder preparation techniques, among which mention may be made of powder metallurgy and liquid processing, such as the sol-gel technique.

According to the sol-gel technique, the powders are thus obtained from molecular metal precursors added to a medium comprising an organic or aqueous solvent. These molecular metal precursors comprise the metallic elements that are intended to be used in the composition of the constituent oxide ceramic of the powder. These precursors may be metal alkoxides or metal salts. The medium comprising an organic solvent is generally an alcoholic medium, the function of this medium being to dissolve the molecular precursors. The medium may also be an aqueous medium.

Using this technique, two routes may be envisaged:
a polymeric route; and
a colloidal route.

According to the polymeric route, the solution obtained by dissolving the molecular precursors in said organic medium is then hydrolysed, in general, by the addition of an aqueous acid or basic solution, so that the abovementioned precursors condense and form a gel, that is to say a solid amorphous three-dimensional network that entraps the organic medium. The next step consists in drying the gel so as to eliminate the interstitial solvent, after which a dry gel, (called a xerogel) is recovered, followed by an optional step of milling this xerogel if the latter is in a form other than a powder. Depending on the nature of the powder to be obtained, it may be necessary to carry out, after the drying, heat treatment steps such as a calcination step, so as to eliminate the residues of organic compounds that might remain and also an annealing step, intended to crystallize the powder in the desired crystal system.

According to the colloidal route, the solution obtained by solubilizing or dissolving the abovementioned molecular precursors is hydrolysed so as to form a dispersion of small oxide particles. Next, the solvent is evaporated and the oxide particles obtained are calcined, after which the desired oxide powder is obtained.

Advantageously, the powder is prepared from the sol-gel solution in which the powder will be subsequently dispersed in order to form the dispersion.

A variant forming part of the sol-gel technique consists in preparing the oxide ceramic powders by heating precursors suspended or dissolved in an aqueous medium at a high temperature and/or high pressure. The precursors are generally inorganic metal compounds, such as metal salts, metal oxides or organometallic compounds. They are brought into contact with an aqueous medium, generally in an autoclave, and with stirring, at a working temperature above the boiling point of water. This temperature is chosen so as to decompose the abovementioned precursors and allow the reaction of formation of the desired oxide ceramic particles to take place. The heating may be continued for a time of possibly between a few minutes and one or more hours, during which the pressure and the temperature are kept constant. After this time, the heating is stopped and the temperature and pressure are returned to room temperature and atmospheric pressure respectively. Next, the product, which is in the form of an oxide powder, is recovered, for example by filtration. This technique is generally termed a hydrothermal technique.

The powders used within the context of the present invention advantageously have a mean particle diameter ranging from 10 nm to 100 μm. Before the particles are incorporated into the abovementioned sol-gel solution, they may be made to undergo a milling step, for example by attrition milling, so as to obtain finer particles.

The oxide ceramic precursor solution, in which the powder is dispersed, is obtained, as its name indicates, by the sol-gel technique, more precisely by solubilizing or dissolving one or more molecular precursors as defined above in an organic medium.

According to the invention, the powder may be incorporated into the sol-gel solution with a content possibly up to 80% by weight relative to the total weight of the dispersion, preferably with a content ranging from 10 to 60% by weight. This content of powder to be incorporated may be readily chosen by a person skilled in the art according to the desired layer thickness.

The dispersion prepared is then deposited in the form of a layer by liquid processing (as explained above) on a substrate as defined above.

The deposition rate is chosen according to the desired thickness of the layer. In general, the thickness of each layer deposited ranges from 0.05 to 15 μm.

In the case of the dip coating technique, the substrate to be coated is dipped into the dispersion prepared beforehand and then withdrawn at a predetermined rate. The rate of withdrawal is generally between 1 cm/min and 30 cm/min. The liquid deposition techniques, such as spin coating, laminar-flow coating and dip coating, have the advantage of allowing the thickness of the deposited layers to be precisely controlled.

This deposition step is repeated one or more times so as to obtain a multilayer film consisting of at least two layers and possibly, for example, up to 50 layers. The number of times this step is repeated will be set by the person skilled in the art according to the thickness of the desired multilayer film film, which may possibly be greater than 1 μm.

The process of the invention also includes a ceramization step by heat treatment of said layers, that is to say a heat treatment step carried out on the abovementioned dispersion, for the purpose of converting the sol-gel solution into the corresponding ceramic.

According to a first alternative, the heat treatment may be carried out layer by layer. In this case, the heat treatment generally comprises, in succession:
a step of drying the layer at a temperature suitable for causing gelation of said layer;
a calcination step at a temperature suitable for eliminating the organic substances within the layer; and
an annealing step at a temperature suitable for crystallizing the layer as an oxide ceramic.

This heat treatment is repeated on each layer deposited, that is to say as many times as there are layers deposited.

According to the invention, it is possible for this heat treatment to be completed with a step of annealing the entire multilayer film.

According to a second alternative, the heat treatment may be carried out as follows:
a step of drying each deposited layer;
a step of calcining each deposited layer; and
a step of annealing all the n layers deposited, n ranging from 2 up to the total number of layers deposited.

Whichever alternative is envisaged, the drying generally takes place at a temperature below 100° C. This drying brings the precursors within the sol-gel solution closer together and causes them to condense, forming a gel. During this condensation, organic substances are released, such as alcohols and carbonates. The calcination step, intended to eliminate the organic and/or inorganic substances resulting from the condensation of the molecular precursors, is generally carried out at temperatures above 300° C., for example at a temperature of 340 to 380° C. in the case of organic substances such as alcohols, and at a temperature ranging from 380 to 400° C. for removing the possible carbonates.

Finally, the annealing step is generally carried out at a temperature above 550° C., so as to crystallize the layers.

Once the multilayer film has been produced, the process according to the invention provides a step of impregnating the complete multilayer film with a sol-gel solution as precursor of an oxide ceramic (said solution containing no powder), said solution being identical to or different from that used in the first step and this impregnation step being repeated one or more times. This precursor solution is of the same type as that used as continuous dispersion medium in the abovementioned deposition step or it may be of a different type.

This impregnation step is repeated one or more times. A person skilled in the art will determine the number of impregnation steps to be carried out so as to obtain a surface finish with the least possible roughness. For example, he may set the number of impregnation steps so as to obtain, after these impregnations, surface roughness of the multilayer film film reduced by a factor of 10 compared with an unimpregnated multilayer film film, the roughness being measured by means of a profilometer. These impregnation steps are carried out by means of liquid processing, using the abovementioned techniques, preferably the dip coating technique.

The multilayer film film thus impregnated is then heat treated so as to convert the precursor sol-gel solution impregnating the multilayer film film into the corresponding oxide ceramic.

In a first alternative, the heat treatment may take place at the end of each impregnation step. In this case, it generally comprises a drying step, generally at a temperature of below 100° C., followed by a calcination step intended to eliminate the organic substances and possibly the carbonates resulting from the conversion of the solution into a gel, this step generally taking place at a temperature above 300° C., and finally an annealing step intended to crystallize the oxide ceramic, this step generally taking place at a temperature above 500° C.

In a second alternative, the heat treatment may comprise, in succession:
a drying step at each impregnation;
a calcination step at each impregnation; and
an annealing step every m impregnations, m ranging from 2 up to the total number of impregnations.

A ceramic material having particularly useful piezoelectric properties may be barium strontium titanate (BST), lead niobium zinc titanate (PZNT), lead magnesium niobate (PMN), lead titanate (PT), potassium calcium niobate, bismuth potassium titanate (BKT), strontium bismuth titanate (SBT) or lead zirconate titanate (PZT), in particular a PZT satisfying the formula PbZrₓTi_{(1-X)}O₃ where 0.45≦x≦0.7.

The process of the invention therefore applies quite naturally to the design of PZT piezoelectric coatings.

According to one particularly advantageous method of implementation, the sol-gel solution serving as dispersion medium for the powder will be used as the sol-gel solution for the impregnation step and possibly as the sol-gel solution for preparing powder.

Advantageously, the sol-gel solution serving as dispersion medium for the powder and possibly the sol-gel solution for the impregnation step and possibly the sol-gel solution for the preparation of the powder may be obtained by a process comprising, in succession, the following steps:.
a sol-gel solution as precursor of a PZT ceramic is prepared in an organic medium comprising a diol solvent;
the sol-gel solution prepared above is left to stand for a sufficient time needed to obtain a sol-gel solution having a viscosity that remains substantially constant over time; and
the sol-gel solution thus obtained is diluted to a predetermined level of dilution with the same diol solvent as that used in the first step or a different solvent which is miscible with the diol solvent used for the purpose of the first step.

This process has the advantage of having a step in which the sol-gel solution is stabilized (corresponding to the standing step). This stabilization of the sol-gel solution is due in particular to the fact of placing the sol-gel solution prepared in the first step at room temperature without stirring for a suitable time in order to stabilize the viscosity of said solution. This step corresponds to a maturing of said solution. During this maturing phase the dissolved molecular metal precursors (i.e. the precursors based on lead, titanium and zirconium) condense and polymerize until reaching an equilibrium state. This polymerization is manifested by an increase in the viscosity of the sol-gel solution, until it reaches a value constant over time, when the equilibrium state is achieved. This maturing phase is followed, according to the invention, by a dilution, which has the effect of definitively adjusting the viscosity of the resulting sol-gel solution, thus guaranteeing reproducibility of layer deposition from sol-gel solutions produced under the same operating conditions and also repeatability of the layer deposition, owing to the stability of the sol-gel solution obtained by the process.

In this process, a sol-gel solution as precursor of a PZT ceramic is firstly prepared by bringing together one or more molecular precursors of lead, titanium and zirconium in an organic medium comprising a diol solvent. For example, one particular method of producing such a sol-gel solution consists in preparing a lead-based sol-gel solution in a diol solvent, by dissolving a molecular lead-based precursor in this diol solvent, to which a mixed sol-gel solution based on titanium and zirconium is added, it being possible for said mixed sol-gel solution to be prepared by dissolving a zirconium-based molecular precursor and a titanium-based molecular precursor in the same diol or in a solvent compatible with said diol, namely a solvent miscible with said diol, as is the case for aliphatic alcohols such as propanol. It is preferred for the lead-based sol-gel solution to be initially in excess by 10% relative to stoichiometry. The mixture of said sol-gel solutions may then be taken to reflux, with stirring, at a temperature close to the boiling point of the reaction mixture. Advantageously, the reflux ensures homogenization of the sol-gel solutions mixed together. Preferably, the diol solvent used for preparing the sol-gel solution based on molecular metal precursors is an alkylene glycol having a number of carbon atoms ranging from 2 to 5. This type of solvent helps to make it easier to dissolve the metal precursors, especially by acting as a chelating agent by completing the coordination sphere of lead and, where appropriate, titanium and zirconium.

According to one particular method of implementing the invention, the diol solvent used is ethylene glycol.

According to the invention, the precursors based on lead, titanium and zirconium may be of various types, but commercially available and inexpensive precursors are preferred.

To give an example, it is possible to use, as lead precursor, organic lead salts such as acetates, mineral lead salts, such as chlorides, or lead organometallic compounds, such as alcoholates having a number of carbon atoms ranging from 1 to 4. Preferably, the lead precursor used is a hydrated organic salt, such as lead acetate trihydrate. This precursor has the advantage of being stable, readily available and inexpensive. However, when such a hydrated precursor is used, it is preferable to dehydrate the latter. This is because the presence of water when mixing the sol-gel solutions together would result in premature hydrolysis of the metal precursors followed by a polymerization. What would result from this mixing step would no longer be a mixed sol-gel solution based on lead, titanium and zirconium, but a mixture product resulting in a gel and, consequently, a difficulty in depositing the gel thus produced in the form of films.

For example, the lead acetate trihydrate may be dehydrated by distilling it in the diol solvent used for mixing the sol-gel solutions.

Preferably, the titanium precursors are alkoxides, such as titanium isopropoxide. Likewise, the zirconium precursors are preferably alkoxides, such as zirconium n-propoxide.

It should be noted that, after this first step, a sol-gel solution having a PZT mass equivalent concentration of greater than 20%, preferably from about 20% to about 40%, for example around 26%, may be obtained.

It should be pointed out that the concentrations are expressed in PZT mass equivalents, that is to say as percentage by weight of ceramic that will be obtained after heat treatment relative to the total mass of the sol-gel solution.

Next, the sol-gel solution obtained after the first step of the invention undergoes a “maturing” step. This period consists, as mentioned above, in letting the sol-gel solution stand until its viscosity is constant over time.

Preferably, the sol-gel solution obtained during the first step is left to stand at room temperature, without stirring, for a time ranging from 1 day to 5 weeks.

Once the observed viscosity of the sol-gel solution has stabilized, said sol-gel solution is diluted, so as to obtain lower concentrations of the sol-gel solution prepared beforehand, which in particular makes it easier to use this sol-gel solution subsequently. Thus, starting from a sol-gel solution having a PZT mass equivalent concentration of greater than 20%, said sol-gel solution may thus be diluted in order to obtain, for example, a sol-gel solution having a PZT mass equivalent concentration of 1 to 20%. For example, starting from a 26% concentrated sol, said sol-gel solution resulting from the second step of the process, it is possible to dilute the sol-gel solution so as to obtain a sol-gel solution having a PZT mass equivalent concentration of 20%. This dilution, to a defined level, makes it possible on the one hand to adjust the viscosity to a given value and, on the other hand, to use this sol-gel solution in particular for depositing it in the form of layers.

According to the invention, the dilution solvent must be compatible with the solvent for preparing the concentrated sol-gel solution. It may be identical to the solvent for preparing said sol-gel solution or it may be different and preferably chosen from aliphatic monoalcohols.

The PZT powder is advantageously prepared from a sol-gel solution, the preparation of which is explained below. To obtain a powder from such a sol-gel solution, the steps are such as those explained above, namely:
a gelation step, by hydrolysing the sol-gel solution;
a drying step, after which a xerogel is obtained; and
a heat treatment step, to crystallize the xerogel.

According to the invention, the prepared dispersion is then deposited in the form of layers on a substrate.

This deposition is carried out by liquid processing, such as spin coating, laminar-flow coating, dip coating or doctor-blade coating, preferably dip coating. This deposition operation is repeated one or more times so as to obtain a multilayer film having the desired thickness.

According to the invention, the deposited layers are made to undergo a heat treatment so as to obtain a multilayer film consisting of PZT layers crystallized in the perovskite system. This heat treatment may be carried out in various ways.

In a first alternative, the heat treatment comprises:
a step of drying the layer at a temperature suitable for causing gelation of said layer, this temperature generally being below 100° C.;
a calcination step at a temperature suitable for eliminating the organic substances within the layer; and
an annealing step at a temperature suitable for crystallizing the layer as an oxide ceramic.

This heat treatment is repeated on each layer deposited, that is to say as many times as there are layers deposited.

A final heat treatment may be carried out by means of a step in which the entire multilayer film film is annealed.

In a second alternative, the ceramization step may take place in the following manner:
a step of drying each layer deposited;
a step of calcining each layer deposited; and
a step of annealing all the n layers deposited, n ranging from 2 up to the total number of layers deposited.

Whichever the alternative envisaged, the drying is intended to ensure that said deposited layers undergo gelation. More precisely, this step is intended to evaporate some of the diol solvent and the dilution solvent used in preparing the sol-gel solution serving as continuous dispersion medium. The effective temperature and duration for ensuring the drying may be readily determined by a person skilled in the art, for example using IR spectrophotometry.

Once the layers have gelled, they undergo a calcination treatment carried out at a temperature and for a time that are suitable for eliminating the organic substances resulting from the condensation reactions during gel formation. The calcination temperature is chosen so as to eliminate the organic compounds from the deposited layer and in particular the solvents for preparing and diluting the sol-gel solution and the organic compounds generated by the reaction between the molecular precursors. A suitable temperature is a temperature for which layers having an infrared spectrum no longer containing absorption bands corresponding to carbon species are obtained.

According to this particular method of implementing the invention, the calcination step may be carried out at a temperature between 300 and 390° C. for a time ranging from 1 minute to about 30 minutes.

Finally, the layers once calcined are made to undergo an annealing step. The purpose of this step is to obtain PZT layers crystallized in the perovskite crystal system. The temperature and duration of the annealing are chosen so as to obtain this crystallization, which can be easily checked by structural analysis, such as X-ray diffraction analysis. Preferably, the annealing is carried out at a temperature ranging from about 600° C. to about 800° C. for a time of between about 1 minute and about 4 hours.

The annealing may be implemented using various techniques. For example, the annealing may be carried out in a conventional furnace or else by RTA (Rapid Thermal Annealing).

Once the PZT multilayer film film has crystallized, it is made to undergo several steps of being impregnated with a sol-gel solution advantageously prepared in the same way as that used to form the continuous dispersion medium. These impregnation steps are performed by liquid deposition techniques such as those mentioned above, the technique of dip coating being the most advantageous.

Next, the multilayer film thus impregnated is made to undergo a heat treatment intended to ceramize a sol-gel solution impregnating the multilayer film, this heat treatment being similar to that explained above in a general manner. Advantageously, the impregnation steps are carried out by dip coating.

Thus, thanks to the process of the invention applied to PZT, employing a stable sol-gel solution, it is possible to obtain piezoelectric materials having excellent properties, such as a piezoelectric constant of around 600 pC/N.

The subject of the invention is also piezoelectric oxide ceramic material(s) capable of being obtained by a process as defined above.

The invention will now be described in relation to one particular example of implementation of the invention, given by way of illustration but implying no limitation.

### DETAILED DESCRIPTION OF PARTICULAR EMBODIMENTS

### Example 1

This example illustrates the preparation of a PZT piezoelectric material according to the process of the invention.

In this example, the following are prepared in succession:
a stable sol-gel solution as precursor of a ceramic of nominal composition Pb₁Zr_{0.52}Ti_{0.48}O₃;
a ceramic powder of nominal composition Pb₁Zr_{0.52}Ti_{0.48}O₃; and
a dispersion comprising a ceramic powder as defined above and a stable sol-gel solution as defined above.

### 1) Preparation of a Stable Sol-Gel Solution as Precursor of a PZT Oxide Ceramic of Nominal Composition (Pb₁Zr_{0.52}Ti_{0.48}O₃)

This part illustrates the preparation of a solution as precursor of a PZT ceramic of formula (Pb₁Zr_{0.52}Ti_{0.48}O₃) from a lead-based precursor, namely lead acetate, and from a titanium zirconium precursor, in the form of alkoxides.

The zirconium and titanium alkoxides used were a commercial zirconium n-propoxide as a 70 wt % solution in propanol and titanium isopropoxide. The lead acetate was in the form of the trihydrate.

The viscosity was monitored using a capillary tube viscometer or a rotating cylinder viscometer at a temperature of around 20° C.

According to this particular method of implementation, the preparation of the sol-gel solution included a preliminary phase of preparing a dehydrated lead-based sol-gel solution.

### a) Preparation of a Dehydrated Lead-Based Sol-Gel Solution.

Weighed out in a round bottomed flask, surmounted by a distillation stage, were 751.07 g (1.98 mol) of lead acetate trihydrate and 330 g (5.32 mol) of ethylene glycol. The mixture was homogenized at about 70° C. so as to dissolve the lead acetate. The temperature of the homogeneous solution obtained was then raised so as to dehydrate the lead-based precursor by distillation. 120 g of distillate were collected and the lead concentration of the sol-gel solution was around 2.06 mol/kg.

b) Preparation of the Stable Sol-Gel Solution as Precursor of a Ceramic of formula PbZr_{0.52}Ti_{0.48}O₃.

The preparation starts with 225.13 g (0.792 mol) of titanium isopropoxide being added, under a stream of argon, to 264 g (330 ml) of n-propanol, followed by 401.52 g (0.858 mol) of 70% zirconium n-propoxide in n-propanol and then 458.7 g (412.5 ml) of ethylene glycol. The mixture was left to stand, with stirring, for 20 minutes at room temperature.

Weighed out in a three-necked flask were 1.815 mol of a lead precursor sol-gel solution prepared beforehand, this having a 10% excess in order to compensate for the loss of lead oxide (PbO) during the heat treatment of the films. The Ti/Zr-based sol-gel solution was then rapidly added under a stream of argon, with vigorous stirring (600 rpm). At the end of the addition, a condenser surmounted by a desiccating guard was fitted and the argon stream stopped. The flask was heated to reflux for 2 hours (101° C.) . During the temperature rise, the stirring was slowed to 250 rpm. After reflux, a concentrated mixed sol-gel solution was obtained, having a PZT mass equivalent concentration of around 26%. The mixed sol-gel solution was kept at room temperature without stirring, until a viscosity constant over time was obtained. In this implementation example, the mixed sol-gel solution was kept for 1 week at room temperature without stirring. The concentrated mixed sol-gel solution was then diluted to a PZT mass equivalent concentration of 20%, i.e. a concentration of 0.75 M, by the addition of ethylene glycol.

The sol-gel solution obtained after dilution had an initial viscosity (measured at 20° C.) of 33.4 centipoise. The viscosity of this same sol-gel solution was measured again after 12 months of ageing. A viscosity of 33.25 centipoise was measured (measurement carried out under the same conditions as initially), i.e. a completely negligible and insignificant change. Consequently, it is possible to conclude that the solution underwent no chemical modification during this period of time and that this solution was perfectly stable over time.

### 2) Preparation of a Lead Zirconate Titanate (PZT) Powder

The preparation started by mixing, with stirring, 60 g of the Pb_{1.1}Zr_{0.52}Ti_{0.48}O₃+ε sol-gel solution prepared in point 1) with 20 g of a basic (pH=10) aqueous ammonia solution. The mixture was placed in an oven (at 80° C.) for 30 minutes. A gel was obtained, which was then heated at 200° C. for 6 hours. After this heating, a yellow solid was obtained, which was firstly ground in a mortar and then calcined in a furnace at 700° C. for 4 hours.

### 3) Preparation of the Dispersion

The powder prepared beforehand was preground in a mortar before being mixed with the PZT sol-gel solution prepared in point 1). The proportions were 50/50 by weight. The dispersion obtained was sonicated with stirring for 20 minutes in order to reduce the size of the particles and to homogenize the dispersion. This was all then stirred for at least one day.

### 4) Deposition of the Dispersion

A flexible stainless steel substrate
(measuring 6×3 cm² with a thickness of 200 μm) was used. It was cleaned beforehand with soap and rinsed with water and ethanol.

The substrate was bonded to a support so as to protect one face.

The deposition was carried out using the dip coating technique. The substrate was immersed for 1 minute and then removed at a rate of 10 cm/min. After having been released from its support, the film was then placed on a hotplate at 50° C. for 5 minutes and then at 360° C. for 5 minutes. The solution was kept stirred between each deposition. The stirring was stopped during dip coating. A treatment in a furnace at 600° C. for 10 minutes was carried out after five successive layers were deposited. The final multilayer film consisting of ten layers, was treated in a furnace at 700° C. for 4 hours.

### 5) Impregnation of the Multilayer Film

To impregnate the multilayer film, the sol-gel solution prepared as explained in point 1) was used. The substrate was left immersed in the solution for about 1 minute. The impregnation was carried out by dip coating, the rate of withdrawal being from 5 to 10 cm/min. Each impregnation was followed by heating at 50° C. for 5 minutes, 360° C. for 5 minutes and 388° C. for 10 minutes. The heat treatment was carried out on a hotplate for the coatings produced on one face. After four impregnations, a 600° C. treatment for 10 minutes was carried out (on a hotplate and in a furnace). The operation was repeated until apparent saturation of the film was obtained. Impregnation was considered to be terminated when the roughness of the film measured by a profilometer, was reduced by a factor of 10. In this example, seventeen impregnations were carried out. The multilayer film was finally annealed at 700° C. for 4 hours. The total thickness of the film was 35 μm.

6) Measurement of εᵣ and d₃₃.

To measure εᵣ and d₃₃, the film obtained was metallized with aluminium by sputtering or evaporation, the thickness deposited being 4000 Å.

The relative permittivity was measured using an HP4284 dielectrometer at 0 V, 10 kHz and 30 mV.

The charge constant was measured after polarizing the film in an oil bath at 90° C. in an electric field of 6-9 kV/mm.

The results are given in the following table:

ε=81

d₃₃=600 pC/N.

### Comparative Example

The powder was prepared as in Example 1.

### 1) Preparation of the Dispersion.

The powder was preground in a mortar before being mixed with the PZT precursor solution as prepared in Example 1. The proportions were 50/50 by weight. The dispersion was sonicated with stirring for 20 minutes in order to reduce the size of the particles and to homogenize the solution. This was all then stirred for at least one day.

### 2) Formation of the Piezoelectric Material

A flexible stainless steel substrate (measuring 6×3 cm² and 200 μm in thickness) was used. It was cleaned beforehand with soap and rinsed with water and ethanol.

The substrate was bonded to a support so as to protect one face.

A dispersion layer was deposited by the dip coating technique. To do this, the substrate was immersed for 1 minute in the dispersion prepared beforehand and then withdrawn at a rate of 10 cm/min. The substrate coated with the layer was then placed on a hotplate at 50° C. for 5 minutes then 360° C. for 5 minutes. The layer thus treated was then impregnated, by dip coating, using a sol-gel solution prepared as explained in point 1). To do this, the layer was immersed in the solution for about 1 minute and then. withdrawn at a rate ranging from 5 to 10 cm/min. The impregnation operation was then repeated twice. After each impregnation, the specimen was heated at 50° C. for 5 minutes, then 360° C. for 5 minutes. After the three impregnations, the specimen was heated at 388° C. for 10 minutes and then 600° C. for 10 minutes.

The layer deposition/impregnation cycle was repeated four times.

The final multilayer film, consisting of five layers, was finally annealed at 700° C. for 4 hours.

In parallel, another trial was carried out so as to obtain a multilayer film consisting of two layers, each layer being impregnated four times.

3) Measurement of εᵣ and d₃₃.

To measure εᵣ and d₃₃, the film obtained was metallized with aluminium by sputtering or evaporation, the deposited thickness being 4000 Å.

The measurement of the relative permittivity was carried out using an HP4284 dielectrometer, at 0 V, 10 kHz and 30 mV.

The charge constant was measured after polarizing the film in an oil bath at 90° C. in an electric field of 6-9 kV/mm.

The results are given in the following table:
for a multilayer film consisting of five layers with three impregnations per layer:

εᵣ=141

d₃₃=25 pC/N;
for a multilayer film consisting of two layers with four impregnations per layer:

εᵣ=206

d₃₃=5 pC/N.

This thus shows that, when the impregnation is carried out layer by layer, the piezoelectric properties are much inferior than those obtained when the impregnation is carried out on the complete multilayer film film, as demonstrated in Example 1.

1-14. (canceled)

15: Process for preparing material based on one or more piezoelectric oxide ceramics, which comprises, in succession, the following steps:
a) deposition by a liquid route, on at least one face of a substrate, of a layer of a dispersion comprising a powder of an oxide ceramic and a sol-gel solution as precursor of an oxide ceramic, the oxide ceramic powder being piezoelectric and/or the sol-gel solution being a precursor of a piezoelectric oxide ceramic;
b) repetition of step a), one or more times, so as to obtain a multilayer film consisting of at least two layers;
c) heat treatment of said layers for the purpose of converting them into the corresponding ceramic(s);
d) impregnation of the multilayer film obtained at step c) by dip coating it with a sol-gel solution identical to or different from that used in step a);
e) repetition of step d) one or more times; and
f) heat treatment of said multilayer film, for the purpose of converting the sol-gel solution impregnating the multilayer film into the corresponding ceramic.

16: Process according to claim 15, in which the substrate is a material chosen from: stainless steel; steel containing nickel; silicon, optionally platinized; aluminium; alumina; titanium; or carbon.

17: Process according to claim 15, which further includes, before step a), the deposition of a barrier layer on one or both faces of the substrate, this layer being made of a material chosen from SiO₂, Ta₂O₅, ZrO₂, Al₂O₃, TiO₂, PZT, BST and combinations thereof.

18: Process according to claim 15, in which the oxide ceramic powder is present in the dispersion with a content possibly ranging up to 80% by weight relative to the total weight of the dispersion.

19: Process according to claim 15, in which the oxide ceramic powder is present in the dispersion with a content ranging from 10 to 60% by weight relative to the total weight of the dispersion.

20: Process according to claim 15, in which the oxide ceramic powder has a mean particle diameter ranging from 10 nm to 100 μm.

21: Process according to claim 15, in which the deposition of step a) is carried out by dip coating.

22: Process according to claim 15, in which the heat treatment carried out in step c) comprises, in succession, the following steps:
a step of drying each deposited layer at a temperature suitable for causing gelation of said layer;
a step of calcining each deposited layer at a temperature suitable for eliminating the organic substances within the layer; and
a step of annealing each deposited layer at a temperature suitable for crystallizing the layer as an oxide ceramic.

23: Process according to claim 15, in which the heat treatment carried out in step c) comprises, in succession, the following steps:
a step of drying each deposited layer at a temperature suitable for causing gelation of said layer;
a step of calcining each deposited layer at a temperature suitable for eliminating the organic substances within the layer; and
a step of annealing all the n layers deposited, n ranging from 2 up to the total number of layers deposited, said annealing being carried out at a temperature suitable for crystallizing the layers as an oxide ceramic.

24: Process according to claim 15, in which the piezoelectric oxide ceramic material is a material chosen from lead zirconate titanate (PZT), barium strontium titanate (BST), lead niobium zinc titanate (PZNT), lead magnesium niobate (PMN), lead titanate (PT), potassium calcium niobate, bismuth potassium titanate (BKT) and strontium bismuth titanate (SBT).

25: Process according to claim 24, in which the piezoelectric oxide ceramic material is lead zirconate titanate (PZT).

26: Process according to claim 25, in which the PZT precursor sol-gel solution which constitutes the dispersion of step a) is identical to that used for the impregnation of step c).

27: Process according to claim 26, in which the PZT precursor sol-gel solution of the dispersion used in step a) and serving for the impregnation of step c) results from a process comprising, in succession, the following steps:
a sol-gel solution as precursor of a PZT ceramic is prepared in an organic medium comprising a diol solvent;
the solution prepared above is left to stand for a sufficient time needed to obtain a solution having a viscosity that remains substantially constant over time; and
the solution thus obtained is diluted to a predetermined level of dilution with the same diol solvent as that used in the first step or a different solvent which is miscible with the diol solvent used in the preparation step.

28: Material based on one or more piezoelectric ceramics, obtained by a process according to claim 15.
